(19) United States
(12) Patent Application Publication
(10) Pub. No.: US 2014/0003339 A1
(43) Pub. Date: Jan. 2, 2014

(54) MACHINE-TO-MACHINE (M2M) DEVICE AND METHODS FOR 3GPP AND ETSI M2M INTERWORKING

(71) Applicants: Puneet Jain, Hillsboro, OR (US); Anuradha Appaji, Plano, TX (US)

(72) Inventors: Puneet Jain, Hillsboro, OR (US); Anuradha Appaji, Plano, TX (US)

(21) Appl. No.: 13/750,697

(22) Filed: Jan. 25, 2013

Related U.S. Application Data
(60) Provisional application No. 61/667,325, filed on Jul. 2, 2012.

(51) Int. Cl. H04W 92/02

(52) U.S. Cl. CPC H04W 92/02
USPC 370/328

(57) ABSTRACT

Apparatuses and methods for operating in networks according to 3GPP/ETSI interworking architectures are described herein. A machine-to-machine (M2M) device may implement a European Telecommunications Standards Institute (ETSI) Service Capability Layer (SCL). The M2M UE may establish an internet protocol (IP) connection between the SCL and a second device in the network. The M2M device may use the IP connection to provide data on a capability of the M2M device to the second device over an mId reference point. The mId reference point may be implemented in accordance with a standard of the ETSI family of standards.

### CROSS-REFERENCE TO RELATED APPLICATIONS

This application claims priority to U.S. Provisional Patent Application No. 61/667,325 entitled “Advanced Wireless Communication Systems and Techniques” filed on Jul. 2, 2012, the content of which is incorporated herein by reference in its entirety.

### TECHNICAL FIELD

Embodiments pertain to wireless communications. Some embodiments relate to the 3^{rd} Generation Partnership Project (3GPP), Technical Specification Group Services and System Aspects, Architecture enhancements to facilitate communications with packet data networks and applications, 3GPP TS 23.682. Some embodiments relate to the European Telecommunications Standards Institute (ETSI) Technical Specification for Machine-to-Machine Communications (M2M); M2M functional architecture, ETSI TS 102 690. Some embodiments relate to the ETSI Technical Specification for Machine-to-Machine Communications (M2M); 3GPP Interworking, ETSI TS 101 603.

### BACKGROUND

Current 3^{rd} Generation Partnership Project (3GPP) long term evolution (LTE) specifications and current European Telecommunications Standards Institute (ETSI) specifications define requirements and architectures for machine-to-machine (M2M) communications. Some ETSI M2M devices or applications may use 3GPP networks as the underlying internet protocol (IP) network for connectivity between various elements in a system. Thus, there exists a general need to define 3GPP/ETSI interworking architectures, including identification of functional entities, related reference points or interfaces, and procedures for ETSI M2M device communication over 3GPP networks.

### BRIEF DESCRIPTION OF THE DRAWINGS

FIG. 1 illustrates an example portion of a wireless communications network in accordance with example embodiments.

FIG. 2-7 illustrate 3GPP and ETSI interworking architectures in accordance with example embodiments.

FIG. 8 is a block diagram of an M2M device in accordance with example embodiments.

FIG. 9 is a block diagram of a computer device in accordance with example embodiments.

FIG. 10 is a flow diagram of a procedure for machine-to-machine (M2M) device operations in accordance with example embodiments.

FIG. 11 is a flow diagram of a procedure performed by an application server (AS) in accordance with example embodiments.

FIG. 12 is a flow diagram of a procedure for M2M device operations within a communication system supporting ETSI/3GPP interworking architectures in accordance with example embodiments.

### DETAILED DESCRIPTION

The following description and the drawings sufficiently illustrate specific embodiments to enable those skilled in the art to practice them. Other embodiments may incorporate structural, logical, electrical, process, and other changes. Various modifications to the embodiments will be readily apparent to those skilled in the art, and the generic principles defined herein may be applied to other embodiments and applications without departing from the scope of the present disclosure. Moreover, in the following description, numerous details are set forth for the purpose of explanation. However, one of ordinary skill in the art will realize that embodiments may be practiced without the use of these specific details. In other instances, well-known structures and processes are not shown in block diagram form in order not to obscure the description of the embodiments with unnecessary detail. Thus, the present disclosure is not intended to be limited to the embodiments shown, but is to be accorded the widest scope consistent with the principles and features disclosed herein.

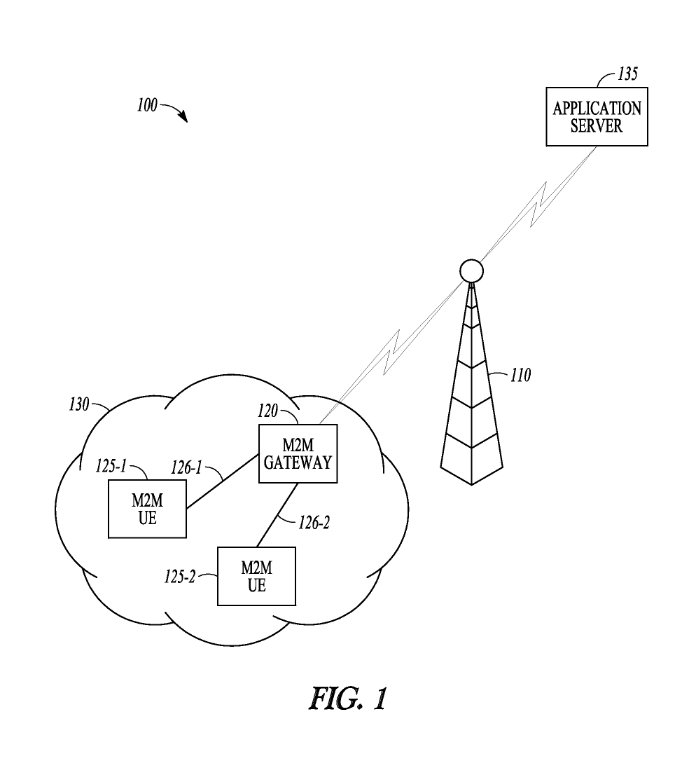

FIG. 1 illustrates an example portion of a wireless communications network 100 in which example embodiments may be implemented. In one embodiment, the wireless communications network 100 comprises an evolved universal terrestrial radio access network (EUTRAN) using the 3rd Generation Partnership Project (3GPP) long term evolution (LTE) standard. In one embodiment, the wireless communications network 100 comprises a universal terrestrial radio access network (UTRAN) using the 3GPP Universal Mobile Telecommunications System (UMTS) standard. In one embodiment, the wireless communications network 100 comprises devices operating in accordance with a standard of the European Telecommunications Standards Institute (ETSI) family of standards. In one embodiment, the wireless communications network 100 includes a Node B (NodeB) or evolved Node B (eNodeB) 110. While only one NodeB/eNodeB 110 is depicted, it will be understood that the wireless communications network 100 may include more than one NodeB/eNodeB 110.

A machine-to-machine (M2M) gateway 120 may communicate with the Node B/eNodeB 110. One or more M2M user equipment (UEs) 125-1, 125-2 may communicate with the M2M gateway 120 over wired or wireless connections 126-1, 126-2. Example wireless communication networks for communications between the M2M UEs 125-1, 125-2 can include a local area network (LAN), a wide area network (WAN), a packet data network (e.g., the Internet), and wireless data networks (e.g., Institute of Electrical and Electronics Engineers (IEEE) 802.11 family of standards known as Wi-Fi®, IEEE 802.16 family of standards known as WiMAX®), peer-to-peer (P2P) networks, among others. The connection 126-1, 126-2 may also be an Ethernet connection, serial bus connection, or other wired connection.

The M2M UEs 125-1, 125-2 may provide capabilities (also referred to as device applications (DAs)) associated with, for example, utility meters, appliances, lighting and HVAC controls, tracking devices, automotive maintenance devices, health telemonitoring equipment, etc. The M2M UEs 125-1, 125-2 may store information related to their respective capabilities in corresponding device Service Capability Layers (DSCLs, not shown). The M2M gateway 120 may also provide capabilities. The M2M gateway 120 may store information related to the M2M gateway's 120 capabilities in a gateway SCL (GSCL, not shown). The GSCL may also store information or data for capabilities attached or associated M2M UEs 125-1, 125-2. Hereinafter the DSCLs and the GSCL may be referred to as a D/G SCL.

The M2M UEs 125-1, 125-2 and the M2M gateway 120 may form a M2M-area network 130. The M2M-area network 130 may be a network such as a smart-home network, an automotive network, etc. The M2M gateway 120 may serve as a bridge between the one or more M2M UEs 125-1, 125-2 and wired or wireless connections, for example 3GPP connections provided by the NodeB/eNodeB 110.

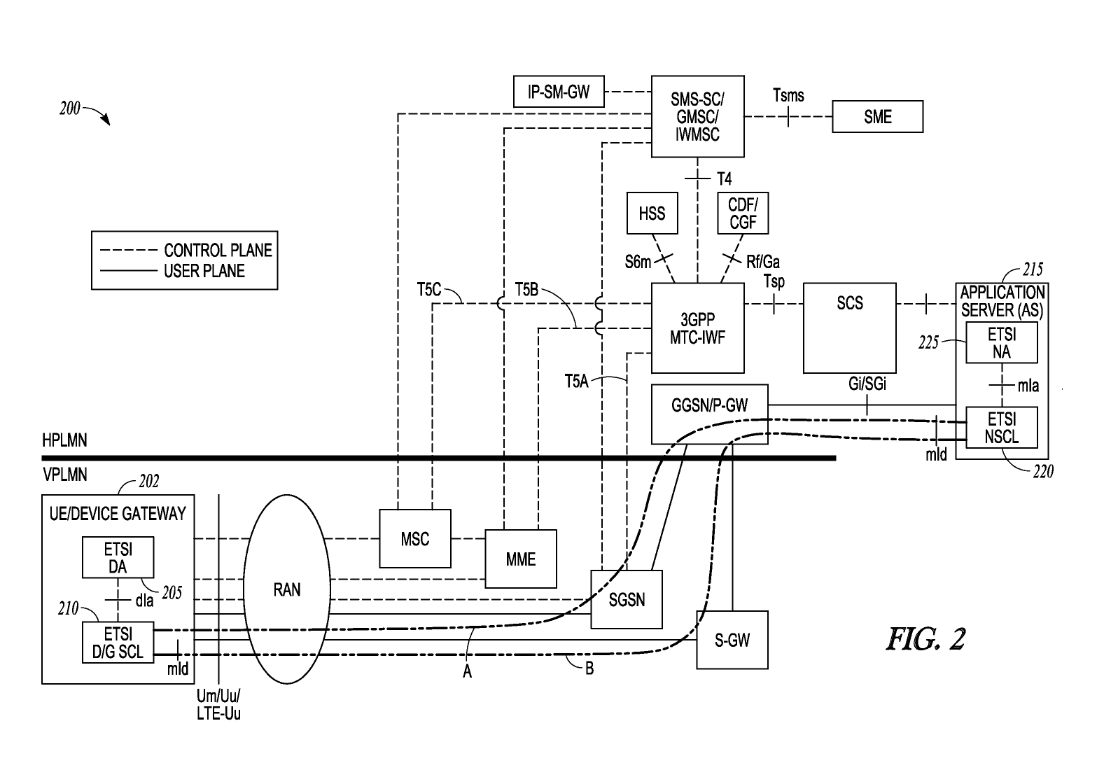

Information and data related to the capabilities of the M2M UEs 125-1, 125-2 and the M2M gateway 120 may be provided to one or more applications, referred to hereinafter as network applications (NA). A NA may reside on, for example, an application server (AS) 135. The network 100 may include other elements that are not depicted in FIG. 1 in the interest of simplicity. For example, the network 100 may include other elements for providing communication between the M2M gateway 120 and the AS 135. Certain of these elements may be described below with respect to FIG. 2-7.

According to current ETSI specifications, the information and data related to the capabilities of the M2M UEs 125-1, 125-2 and the M2M gateway 120 may be provided to the AS over a M2M to device interface (mId). Example embodiments provide architectures for realizing or implementing the mId interface over components of a 3GPP system. Example embodiments may map certain ETSI functionality to different 3GPP network elements as described below with respect to FIG. 2-7.

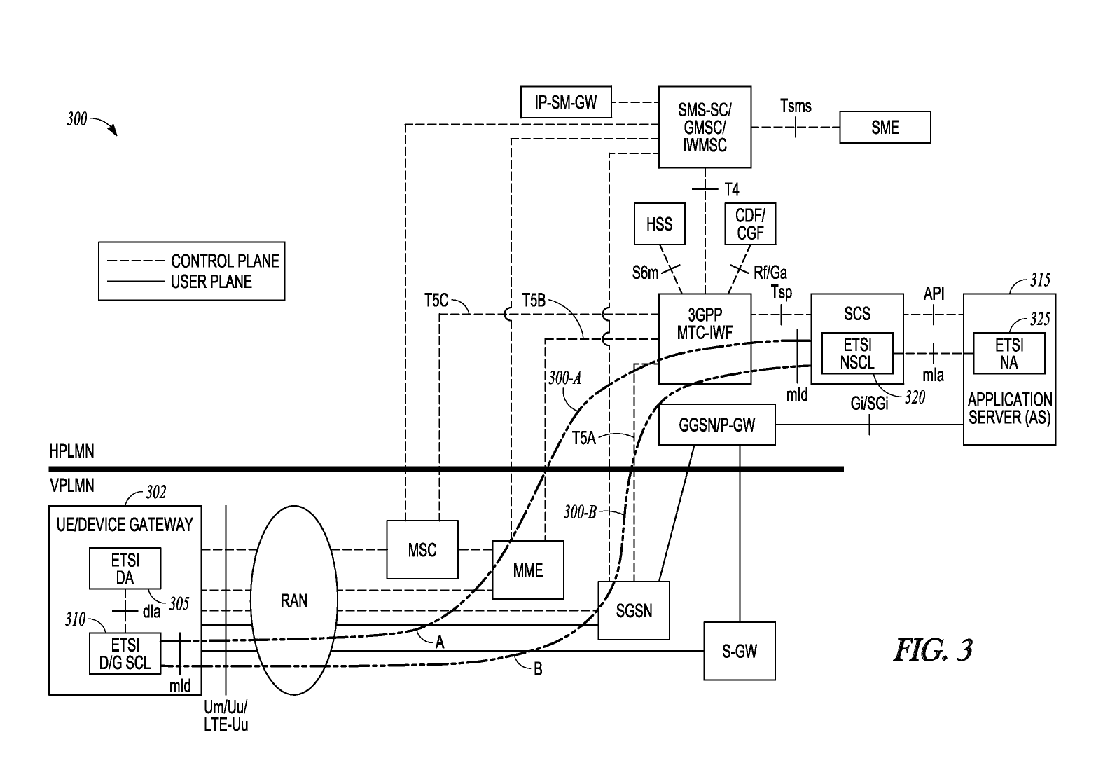

Additional elements of the network 100 (FIG. 1) are described with reference to FIG. 2. It will be appreciated that FIG. 3-7 include at least somewhat similar elements as those described with respect to FIG. 2.

Referring to FIG. 2, the network 200 may include a visited public land mobile network (VPLMN) portion and home public land mobile network (HPLMN) portion. A M2M device 202 may communicate with a Radio Access Network (RAN) over an air interface. The M2M device 202 may be a M2M UE or an M2M gateway, for example. The air interface may be, for example, a Um, Uu, or LTE-Uu air interface. In the case of a network 200 operating according to a standard of the 3GPP UMTS family of standards, the network may include a Mobile Service Switching Center (MSC), a serving general packet radio service (GPRS) support node (SGSN), and a gateway GPRS support node (GGSN). In the case of a network 200 operating according to a standard of the 3GPP LTE family of standards, the network may include a Mobility Management Entity (MME), a serving gateway (S-GW), and a packet gateway (P-GW).

The network 200 may further include a Service Capability Server (SCS). The SCS may implement some functionalities of the AS or the SCS may provide additional services as described below. The network 200 may further include a 3GPP Machine Type Communications-InterWorking Function (MTC-IWF). In the case of a network 200 operating according to a standard of the 3GPP UMTS family of standards, the network 200 may further include a home subscriber server (HSS) and an IP Short Message Gateway (IP-SM-GW). The network 200 may further include a charging data function and/or a charging gateway function (CDF/CGF). The 3GPP MTC-IWF may have connection with the HSS and SMS-SC within the HPLMN and with the SGSN, MME or MSC in the VPLMN. The network 200 may further include Short Message Service-Service Centre (SMS-SC), a Gateway Mobile Switching Center (GMSC), and/or an (Inter working Mobile Switching Centre (IWMSC) for providing Short Message Service (SMS). The network 200 may further include a Short Message Entity (SME) that may send short messages to or receive short messages from, for example, the M2M device 202.

The network 200 may include 3GPP reference points. The reference point Tsms may be used by an entity, for example the SME, to communicate with M2M device 202 via SMS. The network 200 may include a reference point (Tsp) used by the SCS to communicate related control plane signaling with the MTC-IWF. The network 200 may include a reference point T4 used by the MTC-IWF to route device triggers to the SMS-SC in the HPLMN. The network 200 may include a reference point T5a for communication between the MTC-IWF and the serving SGSN. The network 200 may include a reference point T5b for communication between the MTC-IWF and the serving MME. The network 200 may include a reference point T5c for communication between the MTC-IWF and a serving MSC. The network 200 may include a reference point S6m for the MTC-IWF to use for interrogating the HSS. The network 200 may include a reference point Rf for offline charging between MTC-IWF and the CDF. The network 200 may include a reference point Ga between the CDF and the CGF. A Gi or SGi interface may be implemented between the AS 215 and the GGSN or P-GW, respectively.

As described above with respect to FIG. 1, a M2M device 202 may implement a DA 205. The DA 205 may be, for example, a smart home application or an automotive application, etc. The DA 205 may provide information to the D/G SCL 210 through an ETSI device application interface (dIa). The M2M device 202 may be a M2M UE or a M2M gateway. The M2M device 202 may be operable as the M2M UEs 125-1, 125-2 or as the M2M gateway 120 (FIG. 1). When the M2M device 202 operates as an M2M gateway, the M2M device may provide information for capabilities or DAs of associated M2M UEs (not shown).

The M2M device 202 may provide data stored in the D/G SCL to a device such as an AS 215. The AS 215 may be operable as the AS 135 (FIG. 1). The AS 215 may provide a network Service Capability Layer (NSCL) 220. The AS 215 may further include a NA 225 that communicates with the NSCL 220 over a M2M application interface (mIa). In some embodiments (illustrated below with respect to FIG. 3-5), the SCS may include the NSCL 220. In at least these embodiments, the mIa may be implemented between the AS and the SCS. An application programming interface (API) may be provided for developing functionalities related to the communication between the SCS and the AS.

### Initialization and Registration

The M2M device 202 may perform at least one initialization process before using the mId interface to transmit information on capabilities to the NSCL. For example, the M2M device 202 may perform SCL registration with the NSCL.

In the case that the M2M device 202 is a M2M UE, the M2M device 202 may register with the GSCL of an M2M gateway. It will be appreciated that if the M2M device 202 is a M2M gateway, this operation may not occur. Based on this registration, the GSCL of the M2M gateway may store an identity of a DA 205 associated with the M2M device 202. The GSCL of the M2M gateway may further store other parameters such as access rights and notification channels for the DA 205, and other parameters specified by a standard of the ETSI family of standards.

Subsequently, the GSCL may register with the NSCL 220. Based on this registration, the NSCL 220 may store an identity of the GSCL. The NSCL 220 may further store other parameters such as access rights and notification channels for the GSCL, and other parameters specified by a standard of the ETSI family of standards. The NSCL 220 may store parameters related to the attached devices of the M2M gateway. For example, the NSCL 220 may store parameters related to the M2M device 202 that registered with the GSCL.

The NSCL 220, in turn, may register with the GSCL. The GSCL similarly stores a resource representing the NSCL 220. The GSCL may store parameters such as the access rights and notification channels of the NSCL 220, and other parameters specified by a standard of the ETSI family of standards. The NA 225 may further register with the NSCL 220. Based on the NA registration, the GSCL may in turn store identity information of the NA 225.

Security mechanisms may be implemented for the mId interface. For example, the M2M device may need to have encryption keys for establishing a secure connection. Having registered and performed security measures, the M2M device 202 may establish internet protocol (IP) connectivity with the 3GPP network and provide data stored in the D/G SCL 210. The data may represent information concerning the capabilities of the M2M device. The M2M device 202 may transmit the data to the NSCL over the IP connection using the ETSI mId interface.

### Interworking Architectures

FIG. 2 illustrates a direct interworking model over a user plane. The mId interface may be realized over the NSCL 220, over the GGSN (for UMTS systems) or the P-GW (for LTE systems), and over the SGSN (for UMTS systems) or the S-GW (for LTE systems) to the D/G SCL 210. The UMTS realization is illustrated in curve A, and the LTE realization is illustrated in curve B.

In at least one embodiment, the SME may be collocated with the NSCL 220. In at least this embodiment, realization is over the NSCL/SME, over the Tsms interface, and thereby over one of the MSC, MME or SGSN to the D/G SCL 210.

FIG. 3 illustrates an indirect/hybrid interworking model over a 3GPP control plane. Communication between the D/G SCL 310 and the NSCL 320 may occur via the MTC-IWF. The MTC-IWF may provide device triggering and protocol translation over the Tsp interface. In at least this embodiment, a mobile network operator (MNO) may have a higher degree of control, relative to the direct interworking model of FIG. 2, over M2M applications and M2M provisioning. In at least this embodiment, the NA 325 resides in the AS 315. The NSCL 320 resides in the SCS and the mIa reference point is therefore implemented between the AS 315 and the SCS 320. The SCS may be controlled by the MNO or by the M2M service provider. The mId interface may be realized over the SCS, and over the MTC-IWF, and over either the MME or SGSN to the D/G SCL 310 as illustrated in curves A and B, respectively. In some embodiments, the NSCL 320 function may be distributed. For example, NSCL 320 functions may be distributed between the SCS and the MTC-IWF.

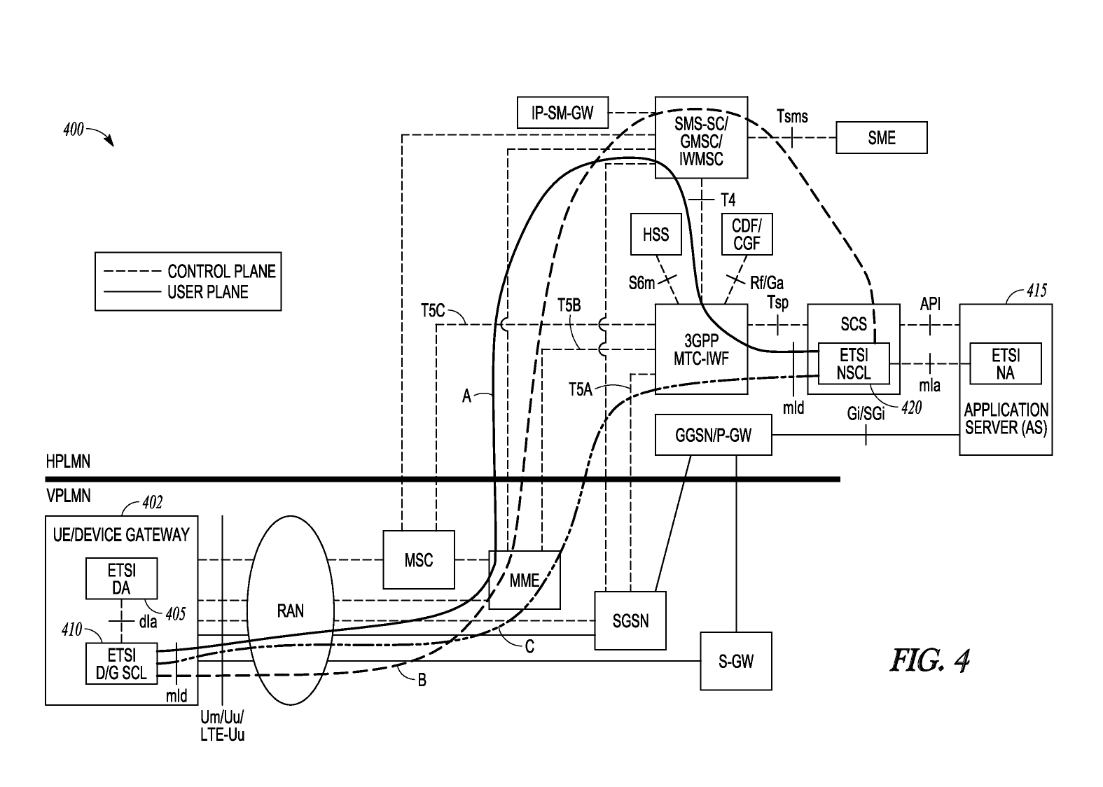

FIG. 4 illustrates further embodiments for realizations of the mId interface under the indirect/hybrid interworking model over the 3GPP control plane. As illustrated in curve A, the mId interface may be realized over the NSCL 420, over the MTC-IWF using the Tsp interface, over the SGSN or MME using T5a or T5b, to the D/G SCL 410. As illustrated in curve B, the mId interface may be realized over the NSCL 420, over the MTC-IWF using the Tsp interface, over SMS-SC using the T4 interface, and over the MSC, SGSN, or MME to the D/G SCL 410. As illustrated in curve C, the SME may be collocated with the NSCL 420 and implemented as part of SCS. The mId interface may then be realized over the NSCL/SME, over the SMS-SC through the Tsms interface, and over the MSC, SGSN, or MME to the D/G SCL 410.

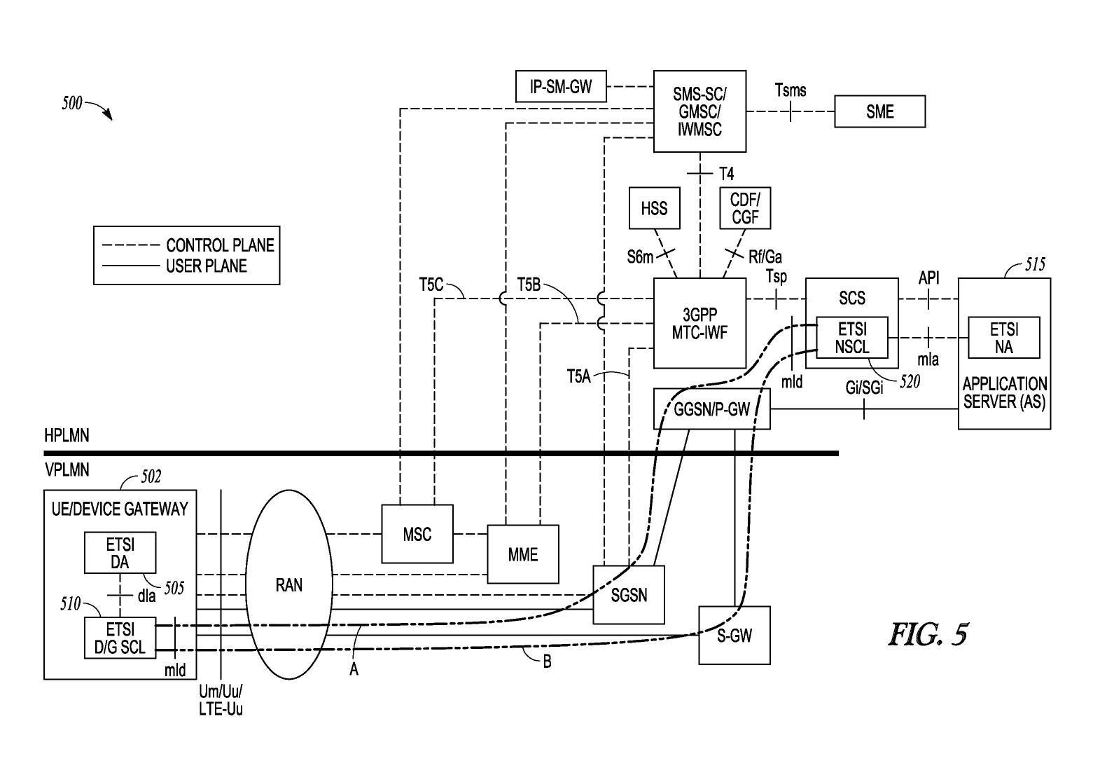

FIG. 5 illustrates embodiments for realizations of the mId interface under the indirect/hybrid interworking model over a 3GPP user plane. As illustrated in curves A and B, communication between the D/G SCL 510 and the NSCL 520 may occur through the MTC-IWF. The NSCL 520 may be implemented on the SCS.

The MTC-IWF provides functionality such as device triggering and protocol translation over the Tsp interface. In at least these embodiments, a mobile network operator (MNO) may have a higher degree of control over M2M applications and M2M provisioning. The SCS may be controlled by the MNO or by the M2M service provider. ETSI M2M procedures may be performed over the user plane. Some features such as device triggering and small data transmission may be realized over the 3GPP control plane through the Tsp interface.

In some embodiments, the NSCL 520 function may be distributed. For example, NSCL 520 functions may be distributed between the SCS and the MTC-IWF. The mId interface may be realized over the NSCL 520, over the GGSN (for UMTS systems) or the P-GW (for LTE systems), and over the SGSN (for UMTS systems) or the S-GW (for LTE systems) to the D/G SCL 210. The UMTS realization is illustrated in curve A, and the LTE realization is illustrated in curve B.

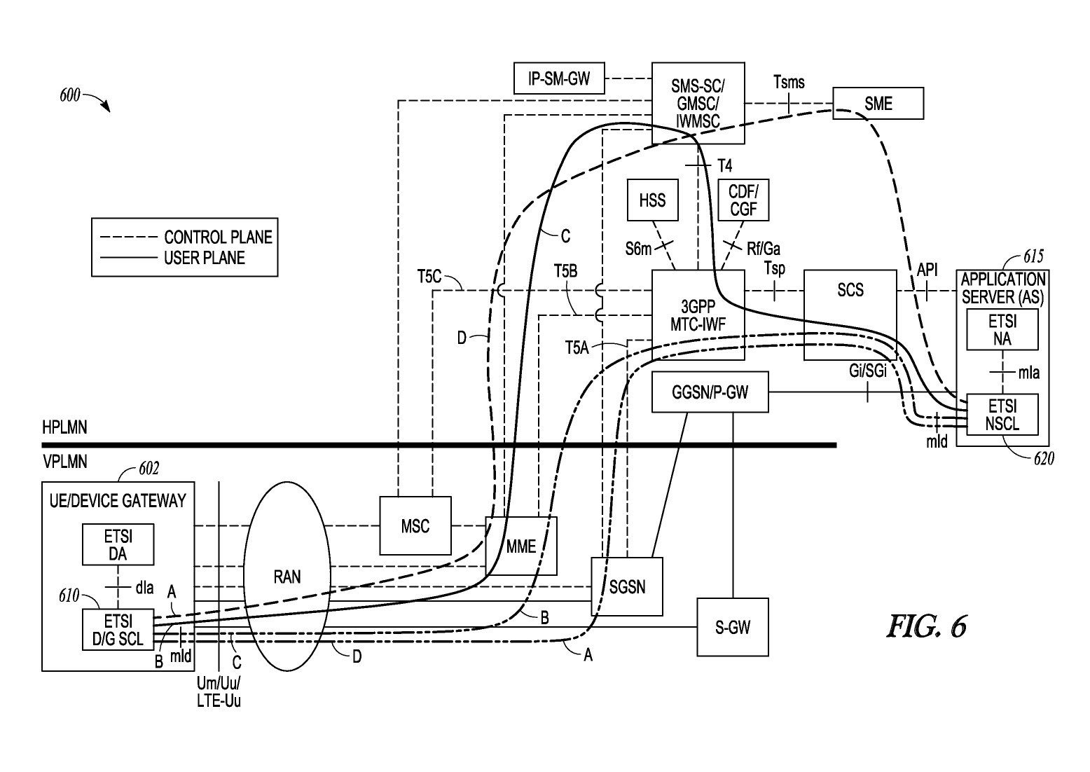

FIG. 6 illustrates an indirect/hybrid interworking model over a 3GPP control plane. Embodiments illustrated in FIG. 6 may be at least somewhat similar to embodiments illustrated in FIG. 3-4, with an exception that the NSCL 620 may be implemented in the AS 615. Communication between the D/G SCL 610 and the NSCL 620 may occur via the MTC-IWF. The MTC-IWF provides device triggering and protocol translation over the Tsp interface. In at least this embodiment, a mobile network operator (MNO) may have a higher degree of control over M2M applications and M2M provisioning. The SCS may be controlled by the MNO or by the M2M service provider.

As illustrated by curves A and B, the mId interface may be realized over the NSCL 620, over the SCS, over the MTC-IWF using the Tsp interface, over either the SGSN or MME using T5a or T5b, respectively, and to the D/G SCL 610. As illustrated by curve C, the mId interface may be realized over the NSCL 620, over the SCS, over the MTC-IWF using the Tsp interface, over SMS-SC using the T4 interface, and over either the MSC (not illustrated), the SGSN (not illustrated), or the MME to the D/G SCL 610. It will be noted that the SME may be collocated with the NSCL 620 and implemented as part of the AS 615. Accordingly, as illustrated by curve D, the mId interface may be realized over the SME/NSCL 620, over the SMS-SC using the Tsms interface, and over either the MSC (not illustrated), the SGSN (not illustrated), or the MME to the D/G SCL 610.

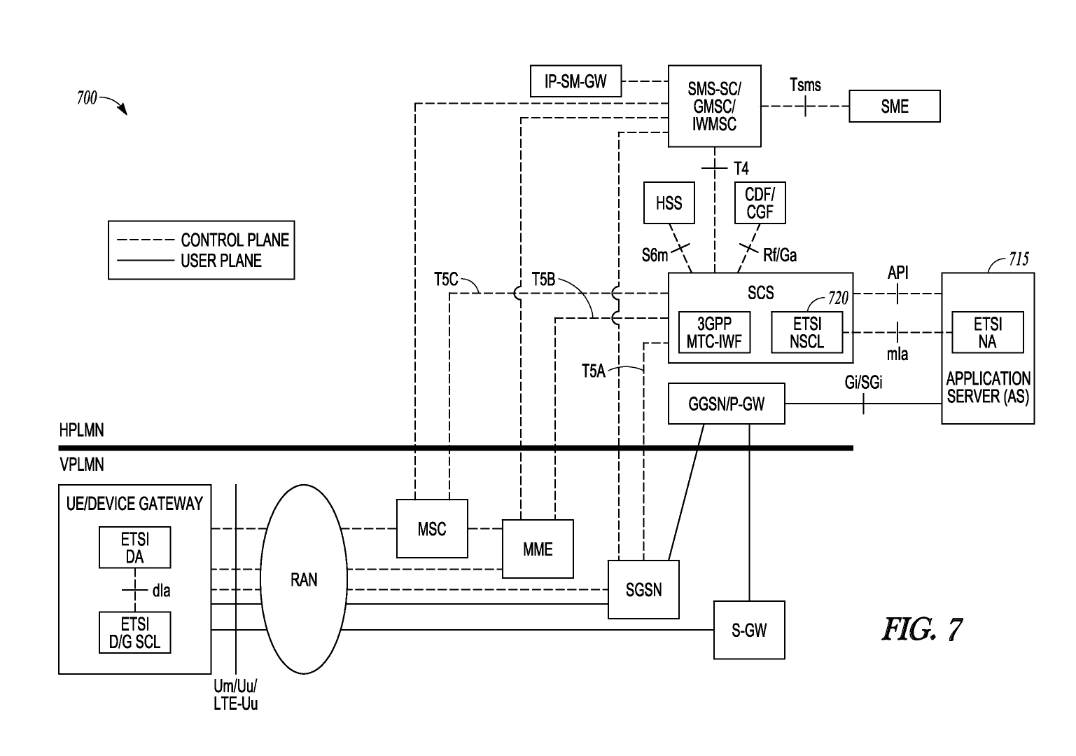

FIG. 7 illustrates that the NSCL 720 may be located in the MTC-IWF. Example embodiments similar to those described above with respect to FIG. 3-6 may be similarly or somewhat similarly implemented in the architecture of FIG. 7.

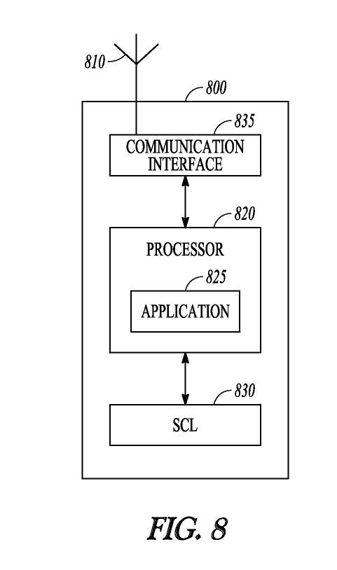

FIG. 8 shows the basic components of a UE 800 in accordance with some embodiments. The UE 800 may be suitable as a M2M UE 125-2, 125-2 or as an M2M gateway 120 (FIG. 1) or as MTC device 202, 302, 402, 502, 602 (FIG. 2-6). The UE 800 may support methods for ETSI/3GPP interworking, in accordance with embodiments. The UE 800 may include one or more antennas 810 arranged to communicate with a base station (BS), the NodeB/eNodeB 110, and/or wireless local area network (WLAN) access points. The UE 800 further includes a processor 820. The processor may include instructions to execute an application 825. The application 825 may be, for example, a DA as discussed above with respect to FIG. 2-7. The UE 800 may include a memory to store information of a service capability layer (SCL) 830 as described above. The UE 800 may further include a communications interface 835.

Example embodiments allow the UE 800 to perform M2M communications in a wireless communication network. The one or more processors 820 may implement an ETSI SCL. As described above, the SCL may be a DSCL or a GSCL, and may be referred to hereinafter as a D/G SCL.

The communication interface 835 may establish an IP connection between the SCL and a second device. As described with respect to FIG. 1-7, the second device may be an AS, SCS, or other network component.

The SCL 830 may use the IP connection to provide data on a capability of the UE 800 to the second device over an mId reference point. The mId reference point may be implemented in accordance with a standard of the ETSI family of standards. The mId reference point may be realized as described above with respect to FIG. 2-7. In an example embodiment, the mId reference point may be implemented over a 3GPP user plane, and the mId reference point may be implemented over a Gi/SGi interface or a Tsm interface of the 3GPP user plane. The mId interface may be implemented over the 3GPP control plane.

The one or more processors 820 may register the capability with the second device using a short message service (SMS) communication over a 3GPP T4 interface. The capability may be an application, for example a DA executing on the M2M device. The application may be a smart-home application, a meter application, or an automotive application, etc. as described above with respect to FIG. 1.

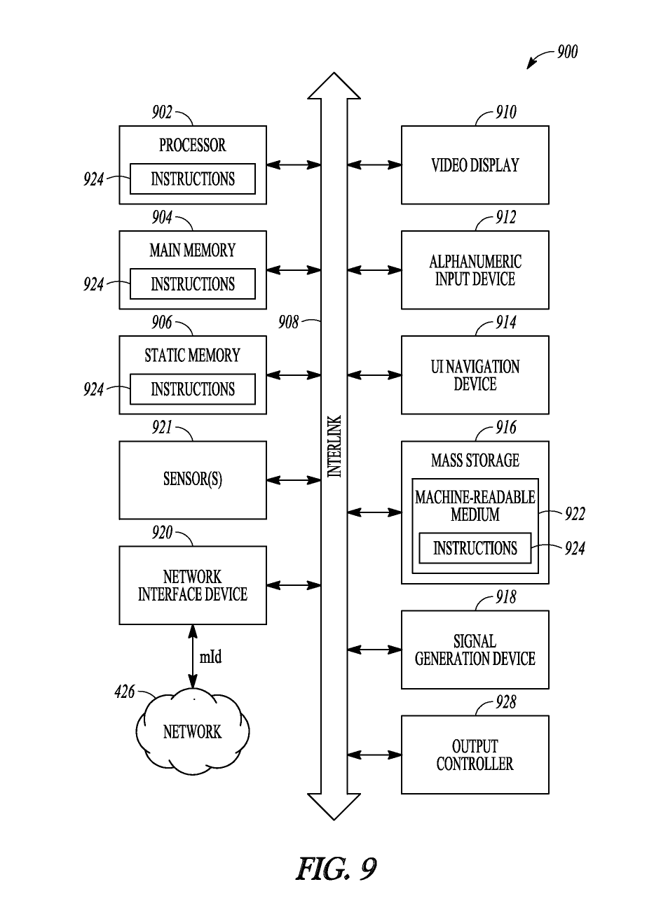

FIG. 9 illustrates an example block diagram showing details of a computing device 900 for performing methods according to some embodiments. The computing device 900 may be suitable as an application server 135 (FIG. 1) or an application server 215, 315, 415, 515, 615, 715 (FIG. 2-7) or other network component. The computing device 900 may perform or implement one or more operations of an ETSI NA or an ETSI NSCL as described above with respect to FIG. 1-7.

The computing device 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The computing device 900 may further include a display device 910, an alphanumeric input device 912 (e.g., a keyboard), and a user interface (UI) navigation device 911 (e.g., a mouse). The computing device 900 may additionally include a storage device (e.g., drive unit) 916, a signal generation device 918 (e.g., a speaker), and a network interface device 920.

The processor 902 may be arranged to execute an ETSI NA.

The network interface device 920 may be arranged to provide communication between the NA and an ETSI Network Service Capability Layer (NSCL). The NSCL may be implemented on the computing device 900 or the NSCL may be implemented on one or more other computing devices. For example, the NSCL may be implemented on a 3GPP service capability server (SCS) as described above with respect to FIG. 3-5.

The main memory 904, the static memory 906, and/or the mass storage 916 may be arranged to store parameters of the NSCL. Parameters of the NSCL may include parameters related to the NA such as access rights, notification channels, and identification information, etc. Parameters of the NSCL may further include parameters related to a D/G SCL.

The network interface device 920 may be arranged to implement or realize one or more functionalities of an ETSI mId interface as described above with respect to FIG. 1-7. The network interface 920 may receive registration of capabilities of devices in the wireless communication network over a mId reference point realized over an internet protocol (IP) connection. The mId reference point may be implemented in accordance with a standard of the ETSI family of standards as described above with respect to FIG. 1-7. The processor 902 may be further arranged to store data concerning this registration in the main memory 904, the static memory 906, and/or the mass storage 916. Data concerning the registration may include D/G SCL parameters. D/G SCL parameters may include information and data of DAs related to the D/G SCL, access rights and notification channels for the D/G SCL, identifying information for attached M2M devices, or any other parameters in accordance with a standard of the ETSI family of standards.

The computing device 900 may further include one or more sensors 921, such as a global positioning system (GPS) sensor, compass, accelerometer, or other sensor. The computing device 900 may include an output controller 928, such as a serial (e.g., universal serial bus (USB), parallel, or other wired or wireless (e.g., infrared (IR)) connection to communicate or control one or more peripheral devices (e.g., a printer, card reader, etc.).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the computing device 900. In an example, one or any combination of the hardware processor 902, the main memory 904, the static memory 906, or the storage device 916 may constitute machine readable media.

While the machine-readable medium 922 is illustrated as a single medium, the term “machine readable medium” may include a single medium or multiple media (e.g., a centralized or distributed database, and/or associated caches and servers) that arranged to store the one or more instructions 424.

The term “machine readable medium” may include any medium that is capable of storing, encoding, or carrying instructions for execution by the computing device 900 and that cause the computing device 900 to perform any one or more of the techniques of the present disclosure, or that is capable of storing, encoding or carrying data structures used by or associated with such instructions. For example, the instructions may cause the computing device 900 to implement an ETSI NA and functionalities of an ETSI NSCL as described above.

Non-limiting machine-readable medium examples may include solid-state memories, and optical and magnetic media. In an example, a massed machine-readable medium comprises a machine readable medium with a plurality of particles having resting mass. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). The term “transmission medium” shall be taken to include any intangible medium that is capable of storing, encoding or carrying instructions for execution by the computing device 900, and includes digital or analog communications signals or other intangible medium to facilitate communication of such software.

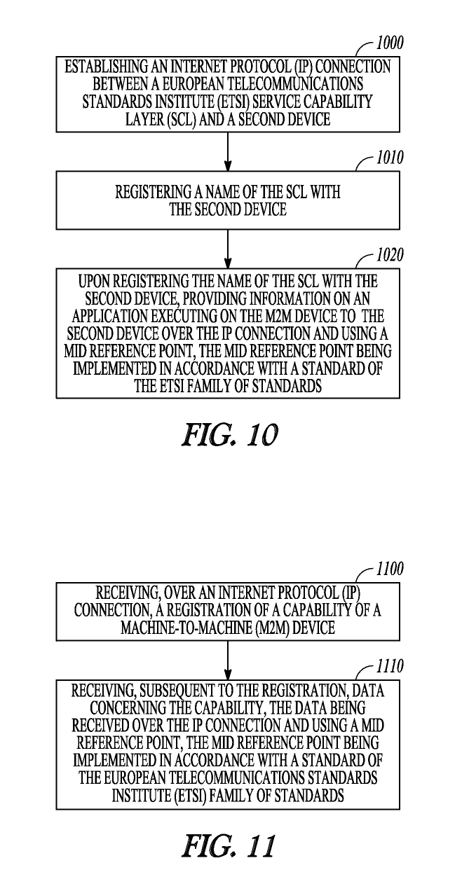

FIG. 10 illustrates operations implemented by a M2M device, for example an M2M UE 125-1, 125-2 or an M2M gateway 120, for operating in a wireless network. In an illustrative example, the M2M UE 125-1 performs these operations. Nevertheless, it will be understood that any other M2M UE or M2M gateway may perform these operations.

In operation 1000, the M2M UE 125-1 may establish an internet protocol (IP) connection between an ETSI Service Capability Layer (SCL) and a second device. The second device may be, for example, an application server (AS) as described above with respect to FIG. 1-7.

In operation 1010, the M2M UE 125-1 registering a name of the SCL with the second device.

In operation 1020, upon registering the name of the SCL with the second device, the M2M UE 125-1 may provide information on an application executing on the M2M device to the second device over the IP connection and using a mId reference point. As described above with respect to FIG. 1-7, the mId reference point may be implemented in accordance with a standard of the ETSI family of standards. The mId reference point may be implemented over a Gi/SGi interface or a Tsms interface within a 3GPP user plane. The mId reference point may be implemented over a 3GPP control plane. The M2M device may register with the second device using a short message service (SMS) communication over a 3GPP T4interface or using a Small Data Transmission over a 3GPP T5 interface.

The M2M UE 125-1 may provide data of an application to other M2M devices 120, 125-2 in a M2M area network 130. The M2M UE 15-1 may receive data of an application executing on the second device using the IP connection over the mId interface. For example, the M2M UE 125-1 may receive information from or about an NA executing on the AS 135.

FIG. 11 illustrates operations implemented by an application server (AS). The AS may be, for example AS 135 (FIG. 1) and/or AS 215, 315, 415, 515, 615, 715 (FIG. 2-7). Example embodiments are described with respect to the AS 135. In operation 1100, the AS 135 may receive a registration of a capability of a machine-to-machine (M2M) device. The AS 135 may receive the registration over an IP connection.

In operation 1110, the AS 135 may receive data concerning the capability. The data may be received subsequent to the registration. The data may be received over the IP connection and using a mId reference point. The mId reference point being implemented in accordance with a standard of the ETSI family of standards as described above with respect to FIG. 1-7. The AS 135 may store parameters related to the registration in a memory as described above with respect to FIG. 9. The memory may be associated with an ETSI NSCL.

The AS 135 may also provide data to the M2M device concerning an application executing on the AS 135. For example, the AS 135 may provide data to the M2M device concerning a NA executing on the AS 135. The data may be provided to the M2M device over the IP connection using the mId reference point. The NA may provide a human-readable user interface for a capability of the M2M device.

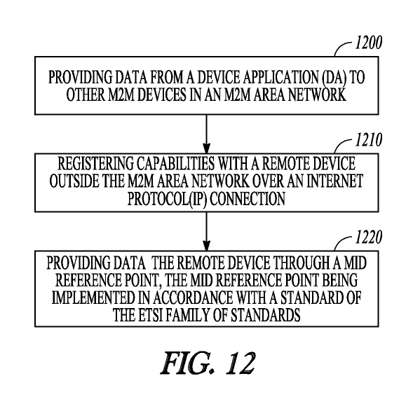

FIG. 12 illustrates operations implemented by a M2M device, for example an M2M UE 125-1, 125-2 or an M2M gateway 120, for operating in a communication system. The communication system may be implemented according to a 3GPP European Telecommunications Standards Institute (ETSI) interworking architecture. In an illustrative example, the M2M UE 125-1 performs these operations. Nevertheless, it will be understood that any other M2M UE or M2M gateway may perform these operations.

In operation 1200, the M2M UE 125-1 may provide data from a DA to other M2M devices in an M2M area network.

In operation 1210, the M2M UE 125-1 may register capabilities with a remote device outside the M2M area network over an internet protocol (IP) connection.

In operation 1220, the M2M UE 125-1 may provide data to the remote device through a mId reference point. The mId reference point may be implemented in accordance with a standard of the ETSI family of standards. The mId reference point may be realized over a 3GPP user plane, a 3GPP control plane, or a combination thereof.

The embodiments as described above may be implemented in various hardware configurations that may include a processor for executing instructions that perform the techniques described. Such instructions may be contained in a suitable storage medium from which they are transferred to a memory or other processor-executable medium.

It will be appreciated that, for clarity purposes, the above description describes some embodiments with reference to different functional units or processors. However, it will be apparent that any suitable distribution of functionality between different functional units, processors or domains may be used without detracting from embodiments. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present inventive subject matter has been described in connection with some embodiments, it is not intended to be limited to the specific form set forth herein. One skilled in the art would recognize that various features of the described embodiments may be combined in accordance with the disclosure. Moreover, it will be appreciated that various modifications and alterations may be made by those skilled in the art without departing from the scope of the disclosure.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A machine-to-machine (M2M) device, comprising:
one or more processors to implement a European Telecommunications Standards Institute (ETSI) Service Capability Layer (SCL);
circuitry to establish an internet protocol (IP) connection between the SCL and a second device; and
a device interface to use the IP connection to provide data on a capability of the M2M device to the second device over an mId reference point, the mId reference point being implemented in accordance with a standard of the ETSI family of standards.

2. The M2M device of claim 1, wherein the mId reference point is implemented over a 3^{rd} Generation Partnership Project (3GPP) user plane.

3. The M2M device of claim 2, wherein the mId reference point is implemented over a Gi/SGi interface of the 3GPP user plane.

4. The M2M device of claim 2, wherein the mId reference point is implemented over a Tsms interface of the 3GPP user plane.

5. The M2M device of claim 1, wherein the mId reference point is implemented over the 3GPP control plane.

6. The M2M device of claim 5, wherein the one or more processors are further arranged to register the capability with the second device using a short message service (SMS) communication over a 3GPP T4 interface.

7. The M2M device of claim 1, wherein the capability is an application executing on the M2M device.

8. The M2M device of claim 1, wherein the application is
a smart-home application,
a meter application, or
an automotive application.

9. A computing device for operating in a wireless communication network, the computing device comprising:
one or more processors to execute an European Telecommunications Standards Institute (ETSI) Network Application (NA);
an application interface to provide communication between the NA and an ETSI Network Service Capability Layer (NSCL);
a memory to store parameters of the NSCL; and
a device interface to receive registration of capabilities of devices in the wireless communication network over a mId reference point realized over an internet protocol (IP) connection, the mId reference point being implemented in accordance with a standard of the ETSI family of standards, the one or more processors further arranged to store the registration in memory associated with the NSCL.

10. The computing device of claim 9, wherein
the NSCL is implemented on a service capability server (SCS) operating in according with a standard of the 3^{rd} Generation Partnership Project (3GPP) family of standards,
the SCS is in communication with the computing device over the application interface.

11. A method, performed by machine-to-machine (M2M) device for operating in a wireless network, the method comprising:
establishing an internet protocol (IP) connection between a European Telecommunications Standards Institute (ETSI) Service Capability Layer (SCL) and a second device;
registering a name of the SCL with the second device; and
upon registering the name of the SCL with the second device, providing information on an application executing on the M2M device to the second device over the IP connection and using a mId reference point, the mId reference point being implemented in accordance with a standard of the ETSI family of standards.

12. The method of claim 11, wherein the mId reference point is implemented over a Gi/SGi interface or a Tsms interface, the Gi/SGi and the Tsms being implemented within a 3^{rd} Generation Partnership Project (3GPP) user plane.

13. The method of claim 11, wherein the mId reference point is implemented over a 3GPP control plane and the M2M device registers with the second device using a short message service (SMS) communication over a 3GPP T4 interface or a Small Data Transmission over a 3GPP T5 interface, the T4 interface and the T5 interface being implemented in accordance with a standard of the 3GPP family of standards for long term evolution (LTE).

14. The method of claim 11, further comprising:
providing data of an application to other M2M devices in a M2M area network.

15. The method of claim 11, further comprising:
receiving data of an application executing on the second device using the IP connection over the mId interface.

16. A method performed by an application server (AS) in a wireless communication network, the method comprising:
receiving, over an internet protocol (IP) connection, a registration of a capability of a machine-to-machine (M2M) device;
receiving, subsequent to the registration, data concerning the capability, the data being received over the IP connection and using a mId reference point, the mId reference point being implemented in accordance with a standard of the European Telecommunications Standards Institute (ETSI) family of standards.

17. The method of claim 16, further comprising:
providing data concerning an application executing on the AS to the M2M device, over the IP connection and using the mId reference point.

18. The method of claim 16, further comprising:
storing parameters related to the registration in a memory, the memory being associated with an ETSI Network Service Capability Layer (NSCL).

19. The method of claim 16, further comprising:
implementing an ETSI Network Application (NA) to provide a human-readable user interface for the capability of the M2M device.

20. A method, performed by a machine-to-machine (M2M) device, for operating within a communication system, the communication system being implemented according to a 3^{rd} Generation Partnership Project (3GPP) European Telecommunications Standards Institute (ETSI) interworking architecture, the method comprising:
providing data from a device application (DA) to other M2M devices in an M2M area network; and
registering capabilities with a remote device outside the M2M area network over an internet protocol(IP) connection; and
providing data the remote device through a mId reference point, the mId reference point being implemented in accordance with a standard of the ETSI family of standards.

21. The method of claim 20 wherein the mId reference point is realized over a 3GPP user plane.

22. The method of claim 20 wherein the mId reference point is realized over a 3GPP control plane.
